(19) United States
(12) Patent Application Publication
(10) Pub. No.: US 2008/0274394 A1
(43) Pub. Date: Nov. 6, 2008

(54) Stacks Of Separators And Electrodes Alternately Stacked One On Top Of The Other And Fixed For Li Storage Batteries

(75) Inventors: Andreas Schormann, Doberschau (DE); Volker Hennige, Duelmen (DE); Gerhard Hoerpel, Nottuln (DE); Christian Hying, Rhede (DE); Peter Pilgram, Recklinghausen (DE)

Correspondence Address: OBLON, SPIVAK, MCCLELLAND MAIER & NEUSTADT, P.C., 1940 DUKE STREET, ALEXANDRIA, VA, 22314, US

(73) Assignee: EVONIK DEGUSSA Gmbh, Essen (DE)

(21) Appl. No.: 12/066,146

(22) PCT Filed: Sep. 5, 2006
(86) PCT No.: PCT/EP2006/066012

§ 371 Date: Mar. 7, 2008

(30) Foreign Application Priority Data
Sep. 8, 2005 (DE) 10 2005 042 916.5

(51) Int. Cl. H01M 2/16; B32B 37/00

(52) U.S. Cl. 429/50; 429/144; 156/60

(57) ABSTRACT

The present invention relates to stacks comprising separators and electrodes stacked alternately one on top of the other and fixed, the stack having, on at least one side and/or edge of the stack, at least one adhesive bond comprising an organic adhesive, which bond adhesively bonds the electrodes and separators of the stack to one another, and a method for the production thereof and the use of these stacks in Li batteries.

The present invention relates to a stack of separators and electrodes stacked alternately one on top of the other and fixed, a method for the production thereof and the use of this stack in Li batteries.

### PRIOR ART

Lithium ion batteries have a very high energy density, based on volume and weight. For mobile compact applications, such as notebooks, digital cameras and cell phones, virtually exclusively Li batteries are therefore now being used. With increasing size of the batteries, there is, owing to the larger quantity of stored energy, a growing potential risk that the stored energy will be released in an uncontrolled manner as a result of destruction of the battery. For the use of Li batteries, for example in hybrid vehicles, suitable safety mechanisms or devices which prevent uncontrolled release of energy must therefore be present.

For the use of large batteries, the safety of the cells must therefore be as great as possible in order to be able to ensure a high level of safety even in the case of incorrect operation or of an accident (in particular on overcharging or on penetration of metal parts). The measures must be passive and should not impair normal operation. The measures must moreover function in all conceivable operating states.

Numerous measures have been taken in the past to increase the safety of Li batteries. Thus, for example, safety valves which open in the case of thermally caused excess gas pressure are now installed in the cells. By the use of PTC ceramics as overcharging protection, use is made of their temperature coefficients (abrupt increase in the coefficient to insulation) to prevent further external charging from taking place (external short-circuit test). By using ceramic separators, thermal destruction of the separator and the resulting short-circuits are prevented. Batteries which contain this ceramic separator, which is sold by Degussa under the name SEPARION®, are distinguished by improved safety, especially with regard to overcharging (overcharge test) and penetration of metal parts (nail penetration test). The use of flame-retardant and fire-stifling electrolyte and overcharge-resistant electrode materials are also being discussed. Moreover, the cells are charged under gentle conditions by UI charging cycles adapted by means of up-circuit electronics.

General information about electrical separators and batteries can be obtained, for example, from J. O. Besenhard in “Handbook of Battery Materials” (VCH-Verlag, Weinheim 1999) or from D. Linden, T. B. Reddy, Handbook of Batteries, Third Edition (McGraw-Hill, New York, 2002).

Li batteries are used in many different sizes (with capacities from a few mAh to some 10 Ah) and shapes (cylindrical, prismatic). A special design comprises stacked prismatic cells (laminated sheet batteries, LSBs), which are very interesting especially for larger cells. For this purpose, positive and negative electrodes and separators which separate the electrodes from one another are stacked alternately. In the case of overcharging, an excess gas pressure forms in the cell. As a result of the excess gas pressure, voids can form between the individual layers and the individual layers can move relative to one another, with the result that short-circuit can occur between the electrodes. As a result of the short-circuit current, the temperature increases further. Polymeric separators may then be thermally destroyed, and complete thermal destruction of the cell may occur.

In order to avoid the movement of the layers, the separators are now usually welded, for example by means of spot welding or line welding, to pockets into which the positive or negative electrode is then inserted. In order to avoid thermal destruction of the separator, ceramic separators or ceramic hybrid separators which so to speak are thermally indestructible can be used today. Such separators are described, for example, in WO 2004/021469, WO 2004/021474, WO 2004/021476, WO 2004/021477, WO 2004/021499, WO 2004/049471, WO 2004/049472, WO 2005/038946, WO 2005/038959 and WO 2005/038960.

By using separators which have a high proportion of ceramic or a low proportion of polymers, the welding (spot welding or line welding) of the separators to pockets which is customary today frequently cannot be used or can be used only with difficulty (for example at higher temperature, higher pressure). Moreover, the pocket construction occupies space and gives rise to additional weight since the weld seam is outside the stack.

U.S. Pat. No. 6,399,240 describes a method for the production of stacks in which the surfaces of the electrodes are treated on the active materials or adjacent to the active material with an adhesive, the electrodes thus treated are stacked one on top of the other with separators as an intermediate layer, and the electrodes with the separators are then adhesively bonded to one another by the action of heat. A disadvantage of this method is that the adhesive has to be applied very exactly to the individual electrodes.

It was therefore an object of the present invention to provide stacks of stacked and fixed electrodes and separators and corresponding Li batteries having stacks, which do not have the stated disadvantages.

It was surprisingly found that electrode-separator stacks can be fixed by simple adhesive bonding on one side or edge of the stack, and that such adhesive bonding can also be used for ceramic separators or separator having a high ceramic proportion.

The present invention therefore relates to stacks of separators and electrodes stacked alternately one on top of the other and fixed, wherein the stacks have, on at least one side and/or edge of the stack, at least one adhesive bond comprising an organic adhesive, which bond adhesively bonds the electrodes and separators of the stack to one another.

The present invention also relates to a method for the production of a stack comprising separators and electrodes stacked alternately one on top of the other and fixed, wherein separators and electrodes are stacked alternately on an electrode and an adhesive bond which has contact at least with one side of the electrodes and separators present in the stack is applied to at least one side of the stack thus obtained.

The present invention moreover relates to the use of a stack according to the invention in an Li battery, and an Li battery which contains a stack according to the invention.

The stacks according to the invention have the advantage over stacks which are not fixed that electrodes and separators are fixed to one another by adhesive bonding in such a way that touching of anodes and cathodes on expansion of the cell or damage due to mechanical stresses can be ruled out. In stacks in which the electrodes and separators are not fixed to one another, the cell may expand as a result of overcharging when the cell is subjected to a thermal load with the result that the individual layers can very easily move relative to one another. If the separator then no longer covers the total area of unlike electrodes, a short-circuit occurs. Since, in contrast to other battery types (Pb, NiCd, NiBeH) not water but a flammable solvent, such as, for example, an organic carbonate, is used as a solvent for the electrolytes, the short-circuit often leads to an explosion and as a rule to combustion of the cells.

Compared with stacks in which pockets are used, the stacks according to the invention have the advantage that they occupy substantially less space and have a lower weight. Moreover, the stacks according to the invention are also safer than stacks which have electrodes inserted into pockets, since the electrodes may be pulled out of the pockets as a result of the above-described expansion of the cell on overcharging. This can likewise lead to a short-circuit when the pressure declines, since the electrodes do not always slide back into the pockets and may thus come into direct contact with the opposite electrodes. Furthermore, the process for the production of stacks having pockets is complicated and tedious since the pockets have to be individually welded or adhesively bonded (3 to 7 s hold time) and many different operations have to be carried out alternately (cutting to length, stacking, welding/adhesive bonding, stacking, etc.), i.e. in any case movements of the tools relative to the stack are required (moving parts which can lead to wear). The handling of the stacks having pockets is also difficult since the layers of pockets and opposite electrodes are not fixed relative to one another. This disadvantage, too, does not exist in the case of the stacks of the present invention.

Another advantage possessed by the stacks according to the invention is that volume and weight are saved through the adhesive bonding of the edges of the individual layers and in addition no surface of the electrodes, in particular no surface of the active material of the electrodes is wetted by the adhesive and is thus no longer available for the actual reaction. If gaps are left between the adhesive bonds, both the electrolyte can penetrate readily into the stack and the gas forming can escape readily in the event of overcharging

With the use, according to the invention, of hotmelt adhesives as adhesives, the method according to the invention has the advantage that the adhesive bonds cool very rapidly and are therefore loadable. No additional process time is then required for curing.

If the method according to the invention is carried out in such a way that two opposite sides of a stack are completely adhesively bonded, the strength of the stack compared with conventional processes and hence the handling properties and the safety can be further increased. The filling with electrolyte and the escape of the gases possibly forming in the event of overcharging, then take place via the orifices at the corner and/or the other sides.

Because ceramic separators can be used in the stack according to the invention, the stacks or the Li batteries which contain the stacks according to the invention can have the positive safety properties described in the publications WO 2004/021469, WO 2004/021474, WO 2004/021476, WO 2004/021477, WO 2004/021499, WO 2004/049471, WO 2004/049472, WO 2005/038946, WO 2005/038959 and WO 2005/038960.

The advantages of using these separators may be summarized as follows:
high porosity
ideal pore size
small thickness
low weight per unit area
very good wetting behavior
high level of safety, i.e. no melt-down but a shut-down effect

The invention is described below by way of example without it being intended to limit the invention, the scope of protection of which is evident from the claims and the description. The claims themselves are also part of the disclosure content of the present invention. If ranges, general formulae or compound classes are stated below, they are intended to include not only the corresponding ranges or groups of compounds which are mentioned explicitly but also all part-ranges and part-groups of compounds which can be obtained by omitting individual values (ranges or subranges) or compounds.

The stacks according to the invention, comprising separators and electrodes stacked alternately one on top of the other and fixed, are distinguished by the fact that the stack has, on at least one side and/or one edge of the stack, at least one adhesive bond comprising an organic adhesive which bond adhesively bonds the electrodes and separators of the stack to one another. The adhesive bond is preferably produced in such a way that all electrodes and separators present in the stack are adhesively bonded to one another by the adhesive bond. The adhesive bond may be produced over the entire side of the stack or only over part-regions of the side of the stack. The adhesive bond can be produced in such a way that, of all electrodes and separators, only the edges of the electrodes and separators are contacted by the adhesive bond. The adhesive bond is preferably produced in such a way that at least one electrode type and/or the separator are contacted by the adhesive bond not only on the edge side but also partly on at least one surface, in the case of electrodes preferably on a surface which is not equipped with active material.

It may be advantageous if the stack has at least one adhesive bond on two or three sides and/or edges. Depending on the geometry of the stack, the number of available sides may vary. Preferably, a stack according to the invention which has the geometry (base area) of a polygon has adhesive bonds on at most all but one side, preferably on at most all but two sides. Because at least one side of the stack is produced without an adhesive bond, expansion and escape of gases forming can be permitted without the stack being damaged. This can also be achieved to a limited extent if spaces are present between the adhesive bonds.

The stack according to the invention preferably has, on at least one side, a sufficient number of adhesive bonds for the spacing of the adhesive bonds (the distance is measured from the end of an adhesive bond considered to the beginning of the neighboring adhesive bond) to be preferably from 20 to 1 cm, preferably from 10 to 2 cm, particularly preferably from 8 to 3 cm and very particularly preferably from 6 to 4 cm.

In the stack according to the invention, the length of the sum of all adhesive bonds on one side may account for from 0.1 to 100% of the length of the side of the stack, the length of the side of the stack being determined only by those parts of the stack in which the active sections of the electrodes are arranged one on top of the other (cf. FIG. 2). Active sections of the electrodes are understood as meaning those which are equipped with the active electrode material. A proportion of from 1 to 70% is preferred for the sum of all adhesive bonds; a proportion of from 5 to 50% is particularly preferred and a proportion of from 10 to 20% is very particularly preferred.

In the stack according to the invention, the width of an individual adhesive bond is preferably less than 3 cm, preferably less than 1 cm and particularly preferably less than 0.5 cm. As a result of the distance of at least 1 cm between the adhesive bonds and a width of the individual adhesive bond of less than 2 cm, a particularly simple and thorough filling of the stack with electrolyte can be achieved.

In another embodiment of the stack according to the invention, the width of an adhesive bond accounts for, preferably, from 50 to 100% of the length of the side of the stack, the length of the side of the stack in turn being determined only by those parts of the stack in which the active sections of the electrodes are arranged one on top of the other. Higher stability of the adhesive bond can be achieved by the large length of the adhesive bond.

If the stack is a stack which, owing to its geometry, has no explicit sides, such as, for example, a stack having an oval or round base area, the side (the edge) of the stack has part-regions, preferably part-regions which account for from 25 to 50% of the side region (edge region) on which no adhesive bond is present. In this way, it is possible to ensure that expansion and escape of gases forming is permitted even in the case of stacks having a base area without corners or edges.

Regardless of the shape of the stack according to the invention, it may be advantageous if at least two adhesive bonds are present on two opposite sides on the stack.

The organic adhesive may be a hotmelt adhesive, such as, for example, Vestoplast® 608 from Degussa, or an epoxy adhesive, in particular a UV-crosslinkable epoxy adhesive, such as, for example, 3121 UV-curing epoxy resin from ThreeBond, or acrylate adhesive, such as, for example, Plex® 9016-O from Röhm or Vitralit™ 4741 from Panacol-Elosol. The organic adhesive is preferably a UV-crosslinking epoxy adhesive, and the adhesive is particularly preferably a UV-crosslinking acrylate adhesive, such as, for example, Plex™ 9016-O from Röhm.

In the stack according to the invention, anodes and cathodes, which are separated from one another in each case by a separator, are preferably stacked alternately one on top of the other as electrodes. The separator present between each electrode may be identical or different throughout the stack. Preferably, the separator is identical throughout the stack.

The stack according to the invention preferably has in each case an electrode as first and last layer, it being possible for these electrodes to be in each case cathodes or in each case anodes. The electrodes bounding the stack are preferably anodes.

In the stack, the separators must terminate at least with the active regions of the electrodes directly adjacent to them. It may be advantageous if the separators present in the stack project on at least one side of the stack beyond the active regions of the electrodes directly adjacent to them. Preferably, particularly in the case of a polygonal base area of the stack, the separators project on at least two sides beyond the cathodes and/or the anodes. It may be advantageous if the separators have a 0.1 to 10 mm, preferably 0.5 to 5 mm and preferably 1 to 2 mm greater length than at least one of the electrode types present in the stack. The separators preferably have a 0.1 to 10 mm, preferably 1 to 6 mm and preferably 2 to 4 mm greater width than at least one of the electrode types present in the stack. It may be particularly advantageous if the separators have both a greater length and a greater width than at least one of the electrode types present in the stack. In this way, the partial contact, described above as preferred, of the adhesive bond with the surface, at least of the separators, can be achieved. Particularly preferably, the separator has the same width and/or length, preferably width, as the anode, and the cathode has a slightly smaller length and/or width, preferably width, than the separator, so that anode and separators are flush and the cathode in this stack projects slightly inward. In this way, dendrite growth can be very substantially prevented.

All known electrodes which can be used as cathodes or anodes may be present as electrodes in the stack according to the invention. Possible electrodes are described, for example, in JP 2003-086174, WO 99/62132 or EP 0 744 782, in which the production of cathodes is described and which is hereby incorporated by reference. Since the stacks are to be used in particular in Li batteries, they have, as anodes, preferably those which have a conductor foil to which the active materials are applied on both sides or one side, preferably on both sides. The anodes preferably have copper foils or copper sheets as conductor foils. The active material may comprise, for example, carbon, preferably graphite, but also hard carbon (amorphous carbon), metallic lithium, tin-based alloys, lithium titanate, metal nitrides or phosphides, which are capable of incorporating the lithium, such as, for example, CoN₃, NiN₃, CuN₃, CoP₃ or FeP₂, nitrides LiₓM_{y}N₂, where M is, for example, Mo, Mn, Fe and preferably x=0.01 to 1, preferably 0.2 to 0.9 and y=1−x, nitrides Li₃₋ₓMₓN, where M=transition metal and preferably x=0.1 to 0.9, preferably 0.2 to 0.8, and/or phosphides LiₓM_{y}P_{z}, where M is, for example, Cu, Mn or Fe and preferably x=0.01 to 1, preferably 0.2 to 0.9, y=1−x and z=an integer which is chosen to be sufficiently high that the compound has no electrical charge, or consist of one or more of these materials. Such and other suitable electrode materials and the production thereof and the production of corresponding electrodes are described, for example, in the documents US 2002-142217, JP 2003-176129, JP 2003-187807, JP 2003-115296, JP 2002289192, JP 2002270174, JP 2002-270157, JP 2002-260657, US 2003-142466, JP 10/003923, JP 2001-266893, JP 2000-067859, JP 2000-067858, JP 2000-067849, JP 11/003707, JP 10/302765, JP 2003-335524, JP 2003-317706, EP 1 249 881, JP 2002-246021, EP 1 168 472, WO 01/22520, EP 0 752 728, US 2002-150818, JP 2002-075376, EP 0 744 782, U.S. Pat. No. 6,566,011 or EP 1 339 642, which are hereby incorporated by reference.

The stack according to the invention preferably has, as cathodes, those which have a conductor foil to which the active material is applied on both sides or one side, preferably on both sides. The conductor foils of the cathodes are preferably aluminum foils or aluminum sheets. The active material may comprise, for example, lithium cobalt oxide LiCoO₂, lithium manganese oxide (spinel) LiMn₂O₄ and manganese oxide MnO₂, lithium nickel oxide LiNiO₂, mixed oxides, in particular LiNi_{1/3}Co_{1/3}Mn_{1/3}O₂, LiNi_{0.8}Co_{0.15}Al_{0.05}O₂, lithium titanate Li₄Ti₅O₁₂, lithium metal phosphate having an olivine structure, such as, for example, LiMPO₄, where M is, for example, Fe, Co or Mn, and/or a nasicon structure, such as, for example, Li₃M₂(PO₄)₃, where M is, for example, Fe or V, and derivatives thereof, such as, for example, LiMPO₄F, where M=transition metal, vanadium oxides, such as, for example, V₂O₅ and LiV₃O₈, or may consist of one or more of these materials. Such and other suitable electrode materials and the production thereof and the production of corresponding electrodes are described, for example, in the documents WO 99/62132, EP 0 744 782, WO 2004/070862, EP 1 049 182, EP 1 325 525, EP 1 325 526, US 2002-182497, US 2002-192551, EP 1 456 895, WO 2003/012899, WO 2004/036671, EP 1 333 935, WO 02/30815, JP 2003-203628, US 2004-002003, EP 1 184 920, EP 1 193 783, EP 1 193 784, EP 1 193 785, EP 1 193 786, EP 1 193 787, EP 1 195 827, EP 1 489 672, EP 1 261 050, EP 1 396 038, WO 97/40541, WO 01/53198, WO 03/099715, EP 1 252 671, EP 1 309 021, WO 01/53198, WO 2003/099715 or WO 2004/057691, which are hereby incorporated by reference.

Information about the production of electrodes which can be used in Li batteries and the production thereof is to be found, for example, in “Lithium Batteries”, G.-A. Nazri, G. Pistoia, Kluwer Academic Publishers, 2004. The electrodes used are preferably such that the conductor foil is not completely coated with active material. The electrodes may have conductor (vanes), via which the electrodes can be connected to the battery pole. However, it is also possible to use electrodes whose conductor foil is such that it directly represents a conductor (vane).

The electrodes and separators are preferably arranged in the stack so that the active material of the electrodes does not project at any point beyond the edge of the separator. Electrodes and separators are preferably arranged in the stack so that the active material of one electrode is opposite to and coincides with the active material of the opposite electrode, separated by a separator. Undesired stray fields which can reduce the life of the batteries are thus avoided.

The stack according to the invention may have all known separators suitable for use in a battery, in particular for use in an Li battery. Currently used separators predominantly comprise porous organic polymer films or comprise inorganic nonwovens, such as, for example, nonwovens of glass or ceramic materials, or ceramic papers. These are offered by various companies, such as, for example, Celgard, Tonen, Ube, Asahi, Binzer, Mitsubishi, Daramic and others. A typical organic separator consists, for example, of polypropylene or of a polypropylene/polyethylene/polypropylene composite. Such PP/PE/PP composite separators are offered, for example, by Celgard LLC, for example under the name Celgard® 2325. The stacks according to the invention can preferably comprise hybrid separators which, in addition to a polymer, also comprise inorganic oxide particles. Such separators are described, for example, in DE 199 18 856.

Particularly preferably, the stacks according to the invention have separators which have a porous substrate having a porous inorganic, electrically nonconductive coating present on and in this substrate and comprising oxide particles adhesively bonded with an inorganic adhesive, the substrate comprising woven or unwoven polymer or glass fibers, preferably polymer fibers, or consisting of these. Such separators are obtainable, for example, from Degussa AG under the name SEPARION® S240 P25 or SEPARION® S450 P35. The production of such separators is described, for example, in the documents WO 2004/021469, WO 2004/021474, WO 2004/021476, WO 2004/021477, WO 2004/021499, WO 2004/049471, WO 2004/049472, WO 2005/038946, WO 2005/038959 and WO 2005/038960. These documents also describe various possibilities regarding how these hybrid separators can be provided with a shut-down layer. If the stacks according to the invention have such separators provided with shut-down layers or particles, the safety of the stack or that of the batteries comprising these stacks can be further increased. Very particularly preferably, the stacks according to the invention therefore have separators which are provided with a shut-down layer or with shut-down particles.

The stacks according to the invention can be obtained for example, by the below-described method according to the invention for the production of a stack from separators and electrodes stacked alternately one on top of the other and fixed.

The method, according to the invention, for the production of a stack from separators and electrodes stacked alternately one on top of the other and fixed is distinguished by the fact that separators and electrodes are stacked alternately on an electrode, and an adhesive bond which has contact at least with one side of the electrodes and separators present in the stack is applied to at least one side of the stack thus obtained.

The application of the adhesive bond to at least one side of the stack can be effected, for example, by applying an organic adhesive, to at least one side of the stack, for example by means of immersion or by means of a hotmelt adhesive gun, particularly preferably by means of injection heads for bead application, large-area heads, spray heads, metering valves, dispensers, and subsequently not moving the electrodes and separators contained in the stack relative to one another until the adhesive has set or cured. The width of the adhesive bond can be adjusted by means of the type of heads used and/or the choice of application method. The thickness of the adhesive bond can be adjusted by means of the amount of adhesive used.

In the method according to the invention for the production of the adhesive bond, an organic adhesive which cures or can be cured directly after application or in a period of up to 60 minutes after application, preferably within from 0.01 to 60 minutes and particularly preferably within from 5 to 10 minutes is preferably used. The organic adhesive may be in particular a thermally activated, chemically activated or radiation-activated adhesive. A preferably used organic adhesive is, for example, a hotmelt adhesive, such as, for example, Vestoplast® 608 from Degussa, or an epoxy adhesive, in particular a UV-crosslinkable epoxy adhesive, such as, for example, 3121 UV-curing epoxy resin from ThreeBond, or acrylate adhesive, such as, for example, Plex® 9016-O from Röhm or Vitralit™ 4741 from Panacol-Elosol. The organic adhesive used is preferably a UV-crosslinking epoxy adhesive and particularly preferably an acrylate adhesive (including UV-crosslinked). After application on the side of the stack, the UV-crosslinkable adhesives are cured within from 0.1 to 60 minutes, preferably within from 5 to 10 minutes, by means of UV light having a wavelength of from 10 to 380 nm, preferably from 315 to 380 nm. UV light of corresponding wavelength can be produced, for example, by means of a UV lamp of the type UV-F 400 from Panacol-Elosol.

It may be advantageous if the side of the stack to which an adhesive bond is to be applied is compressed by exerting pressure, preferably a pressure of at least 0.1 N/cm², preferably from 1 to 10 N/cm². This can also be effected, for example, by exerting an appropriate pressure on the entire stack. Pressure can be exerted, for example, by means of pneumatic or hydraulic rams of suitable shape. The pressing process is preferably maintained until the adhesive has cured or at least partially cured. In this way, it is possible to ensure that as little adhesive as possible penetrates into the area between electrodes and separator, thus preventing the separator area or areas of the active material from becoming blocked with adhesive and thus no longer being available for ion transport.

It may be advantageous if the method according to the invention is carried out in such a way that first a plurality of stacks are stacked one on top of the other using separation layers, which may consist, for example, of material which adheres poorly to the adhesive used such as, for example, silicone or polyvinylidene fluoride (PVDF), and then one or more adhesive bonds are produced. The stacks are then separated again at the separation layers. In this way, adhesive bonds can be produced on a plurality of stacks in one operation, with the result that a higher production rate can be achieved.

In the method according to the invention, anodes and cathodes are preferably stacked alternately one on top of the other as electrode types during stacking. A separator is stacked between the electrodes, the separator preferably having a greater length and/or width than at least one of the two electrode types. It is preferable to use a separator which has a 0.1 to 10 mm, preferably 1 to 6 mm and preferably 2 to 4 mm greater width than the width of the anodes and/or cathodes used. The separator used is preferably a separator which has a greater width than the width of the cathode used. If the separator has a greater width than the width of the anode, the width of the anode or of the cathode can likewise be less than the width of the separator, but is preferably of the same magnitude.

Separators and electrodes used in the method according to the invention may be those described above. The stacking of the electrodes and separators is preferably effected in a manner such that the active material of the electrodes no longer projects along the edge of the separator. Preferably, electrodes and separators are stacked in such a way that the active material of one electrode is opposite to and in coincidence with the active material of the opposite electrode, separated by a separator. The electrodes are stacked so that the conductor foils do not touch unlike electrodes (cf. FIG. 2).

The stacks according to the invention can be used, for example, in an Li battery. Li batteries which contain a stack according to the invention may have, as electrolytes, lithium salts having large anions in carbonates as solvent. Suitable lithium salts are, for example, LiClO₄, LiBF₄, LiAsF₆ or LiPF₆, LiPF₆ being particularly preferred. Organic carbonates suitable as solvents are, for example, ethylene carbonate, propylene carbonate, dimethyl carbonate, ethyl methyl carbonate or diethyl carbonate or mixtures thereof.

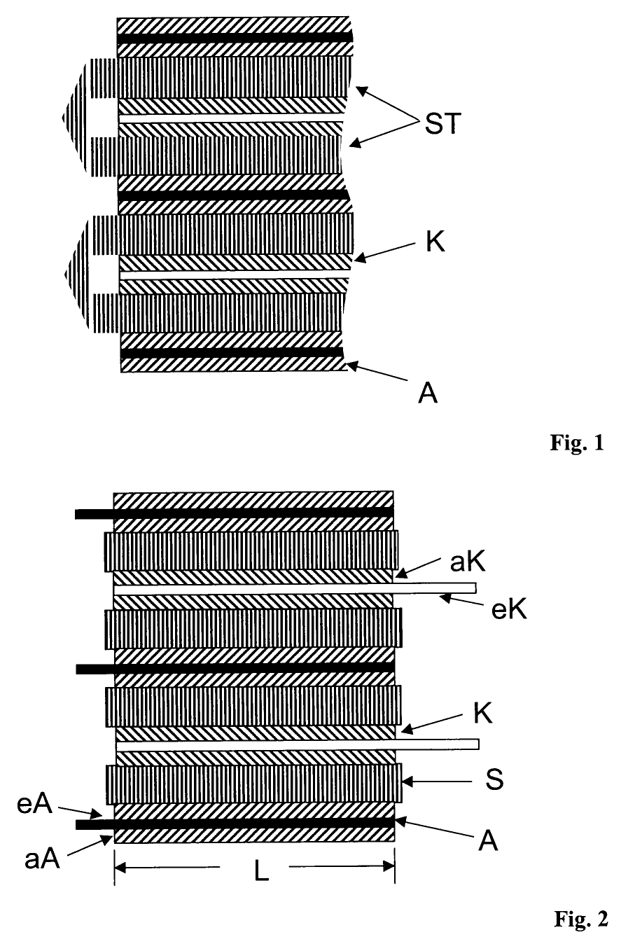

The subject matter of the invention is explained in more detail below with reference to the figures FIG. 1 to FIG. 6, without it being intended to limit the invention to the embodiments shown by way of example there.

FIG. 1 schematically shows the edge of a stack of electrodes and separator pockets according to the prior art. The cathodes K are inserted into the separator pockets ST. The anode A is present between two separator pockets ST and in each case as a cover layer.

FIG. 2 schematically shows the longitudinal side of a stack of electrodes and separators. Therein, S represents the separators, A represents the anodes, which consist of the active materials aA, applied to the conductor foils eA, and K represents the cathodes, which consist of the active material aK, applied to the conductor foils eK. L designates the region in which the active material of one electrode is opposite to the active materials of an opposite electrode. The length is defined as the length over which an adhesive bond may theoretically be present.

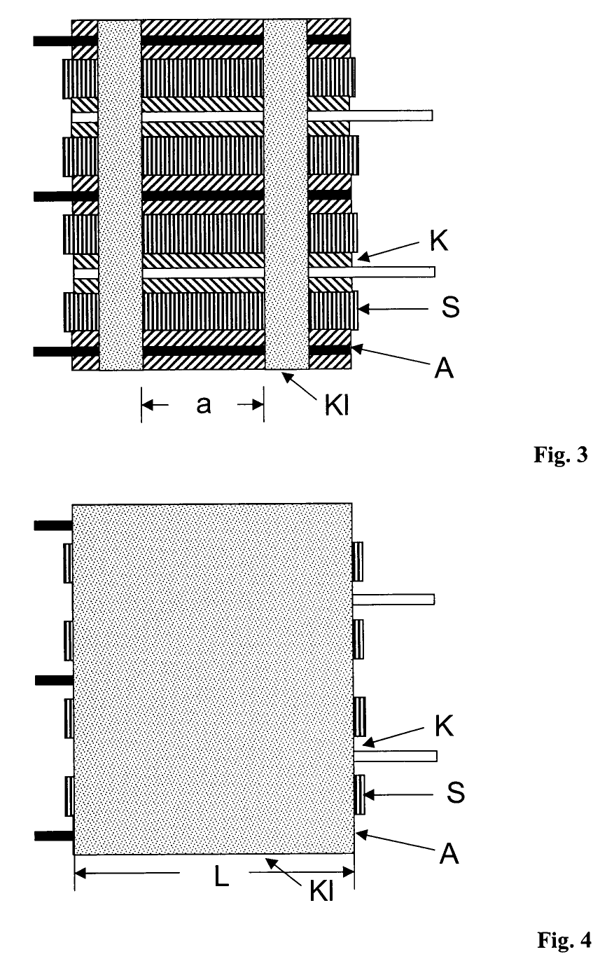

FIG. 3 schematically shows the longitudinal side of a stack of electrodes and separators. Therein, S represents the separators, A represents the anodes and K represents the cathodes. a designates the distance between two adhesive bonds K1 on the side of the stack.

FIG. 4 schematically shows the longitudinal side of a stack of electrodes and separators. Therein, S represents the separators, A represents the anodes and K represents the cathodes. The adhesive bond A1 has in this case a weight which corresponds to the maximum theoretical length L.

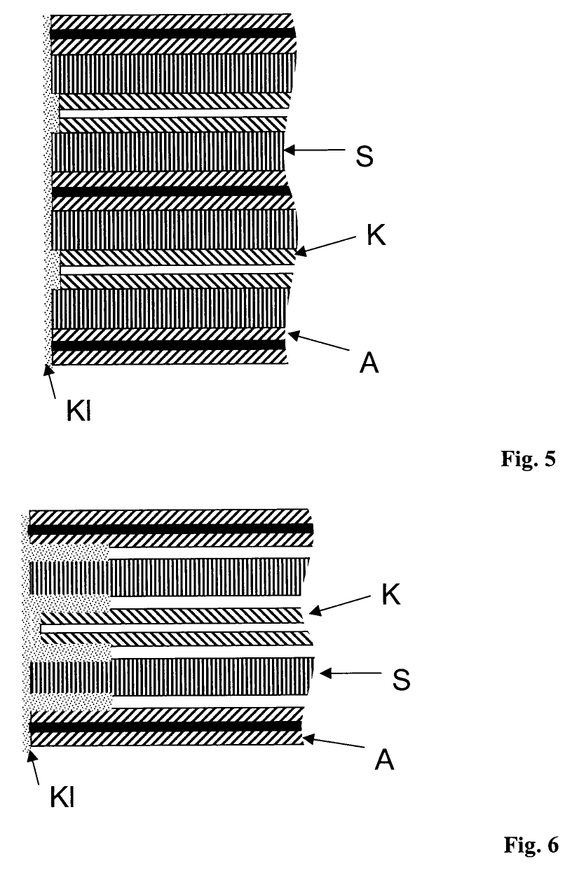

FIG. 5 schematically shows an edge of the cross section of a stack of electrodes and separators according to the invention. The adhesive bond K1 adhesively bonds the edges of the cathodes K, of the separators S and of the anodes A. In addition, a part of the surface of the separator S is also in contact with the adhesive bond.

FIG. 6 schematically shows an edge of the cross section of a stack of electrodes and separators according to the invention, in which the adhesive bond has been produced without a sufficiently great pressure having been exerted on the side of the stack. It is evident that the adhesive of the adhesive bond K1 has run into the voids between cathodes K, anodes A and separators S, with the result that the adhesive bond covers a large part of the surface of the electrodes and of the separators.

The present invention is described by the following examples, without being limited thereto.

### EXAMPLES

The stacks according to the following examples and comparative examples were produced using the separators SEPARION® S 240 P25 or S 450 P35, which are obtainable from Degussa AG and can be produced according to EP 1509960 or DE 10208277.

### Comparative Example 1

### Stack without Adhesive Bonding

A separator S240 P25 (Degussa AG, Germany) having the dimensions 72 mm×126 mm is placed on an electrode A (anode) having the dimensions 70 mm×131 mm (including 7 mm of uncoated copper on one of the narrow sides), according to FIG. 2 (Enax Inc., Japan), so that the separator projects beyond the electrodes by 1 mm on all sides in the region of the copper foil coated with active materials. The opposite electrode K having the dimensions 65 mm×129 mm (including 9 mm of bare aluminum foil on one of the narrow sides) (cathode; Enax Inc., Japan) is placed thereon, it being ensured that the separator completely covers on all sides the region of the aluminum foil coated with active material. The electrodes are arranged in such a way that the bare aluminum foils project from the stack beyond the narrow sides of the cathodes on one side of the stack and bare copper foils project beyond the narrow sides of the anodes on the opposite side of the stack. Further layers of electrodes are then stacked alternately, in each case separated by separators, so that a stack consisting of 16 layers of anodes and 15 layers of cathodes and 30 layers of separators is finally obtained, which stack is bounded by the anodes. The conductor foil projecting at the two opposite ends according to FIG. 2 and belonging in each case to like electrodes are welded to one another and to a metallic conductor vane by ultrasonic welding in the uncoated regions (conductor vane not shown in FIG. 2).

The stacks are difficult to handle because the layers are very poorly connected to one another. The individual layers move very easily relative to one another. This stack is used for constructing a laminate sheet battery by carefully placing the stack in an aluminum housing. The cell is welded using an Audionvac vacuum welding unit (VMS103, from Audion Elektro GmbH, the Netherlands). 1 M LiPF₆ electrolyte in ethylene carbonate (EC):diethyl carbonate (DEC) (1:1), UBE Japan, is introduced into the housing which is still open in a small area. Therefore, the cell is closed, likewise using the vacuum welding unit, and a Maccor Series 4000 charger (Maccor, USA) is then connected. The battery cannot be charged for the first time (cannot be formed) since short-circuits occur in the battery owing to the internal movements.

### Comparative Example 2

### Stack Having Welded Pockets

Separator pockets according to FIG. 1 are produced by first welding 2 layers of the separators S 450 P35 (Degussa AG, Germany) having the dimensions 73 mm×130 mm (on the longitudinal side, 4 mm projection each owing to the welding and the introduction) on the two longitudinal sides by means of a hot press (JoKe, Germany). The welding is effected at 280° C. for 10 s under a contact pressure of 2500 N. A cathode having the dimensions 65 mm×129 mm according to FIG. 1 is then inserted into this pocket. A stack consisting of 16 anodes and 15 separator/cathode pockets is then produced according to FIG. 1. The conductor foils projecting at the two opposite ends of the stack and belonging in each case to like electrodes are welded to one another and to a metallic conductor vane, as in comparative example 1, by means of ultrasonic welding in the uncoated regions.

The stacks are difficult to handle because the components are poorly connected to one another. The individual pockets or anodes move very easily relative to one another. This stack is used for constructing a laminate sheet battery by carefully placing the stack in an aluminum housing. The cell is welded by means of an Audionvac vacuum welding unit (VMS103, from Audion Elektro GmbH, the Netherlands). 1 M LiPF₆ electrolyte in EC:DEC (1:1), UBE Japan, is introduced into the housing which is still open in a small area. Thereafter, the cell is likewise closed by means of the vacuum welding unit, and then connected to the Maccor Series 4000 charger (Maccor, USA). This battery can be charged and cycled without problems. However, both the complicated and time-consuming production process for the pockets and the projecting regions of the pockets, which lead to an unnecessary increase in the size of the battery by 6 mm on the longitudinal side and hence to a reduction in the energy density, are disadvantageous.

### Comparative Example 3

### Stack Having Adhesively Bonded Pockets

Separator pockets according to FIG. 1 are produced by first adhesively bonding 2 layers of separators S 450 P35 (Degussa AG, Germany) having the dimensions 73 mm×130 mm (on the longitudinal side, projecting 4 mm each owing to adhesive bonding and introduction) on the two longitudinal sides. The adhesive used is a UV-curing acrylate adhesive Plex® 9016-O from Röhm GmbH, Germany. The adhesive is applied to the surface extensively over a width of 3 mm, starting from the edge. The two layers are placed one on top of the other and the adhesive is cured with light having a wavelength of about 315 to 380 nm for 15 min using a UV lamp of type UV-F 400 from Panacol-Elosol. A cathode having the dimensions 65 mm×129 mm according to FIG. 1 is then inserted into this pocket. A stack consisting of 16 anodes and 15 separator/cathode pockets is then produced according to FIG. 1. The conductor foils projecting at the two opposite ends of the stack and belonging in each case to like electrodes are welded to one another and to a metallic conductor vane, as in comparative example 1, by means of ultrasonic welding in the uncoated regions.

The stacks are difficult to handle because the components are poorly connected to one another. The individual pockets or anodes move very easily relative to one another. This stack is used for constructing a laminate sheet battery by carefully placing the stack in an aluminum housing. The cell is welded by means of an Audionvac vacuum welding unit (VMS103, from Audion Elektro GmbH, the Netherlands). 1 M LiPF₆ electrolyte in EC:DEC (1:1), UBE Japan, is introduced into the housing which is still open in a small area. Thereafter, the cell is likewise closed by means of the vacuum welding unit, and then connected to the Maccor Series 4000 charger (Maccor, USA). This battery can be charged and cycled without problems. However, both the complicated and time-consuming production process for the pockets and the projecting regions of the pockets, which lead to an unnecessary increase in the size of the battery by 6 mm on the longitudinal side and hence to a reduction in the energy density, are disadvantageous.

### Examples

### According to the Invention

### Example 1

### Stack with Hotmelt Adhesive, Adhesively Bonded Over Lines

A separator S240 P25 (Degussa AG, Germany) having the dimensions 72 mm×126 mm is placed on an electrode A (anode) having the dimensions 70 mm×131 mm (including 7 mm Cu edge), according to FIG. 2 (Enax Inc., Japan), so that the separator projects by 1 mm on all sides beyond the electrodes in the region of the copper foil coated with active material. The opposite electrode having the dimensions 65 mm×129 mm (including 9 mm of bare aluminum foil), (cathode; Enax Inc., Japan) is then placed on top, it being necessary to ensure that the separator completely covers on all sides the region of the aluminum foil coated with active material. The electrodes are arranged in such a way that the bare aluminum foils project from the stack beyond the narrow sides of the cathodes on one side of the stack, and the bare copper foils project beyond the narrow sides of the anodes on the opposite side of the stack. Further layers of electrodes are then stacked alternately, separated in each case by separators, so that a stack consisting of 16 layers of anodes and 15 layers of cathodes and 30 layers of separators finally forms, which stack is bounded by the anodes.

This stack is slightly compressed by means of metal plates above and below the stack with 10 N/cm² and provided according to FIG. 3, at 3 points on the outside of the stack, with one adhesive bead each, which are applied using a hotmelt adhesive gun GKP 200 CE from Bosch, Gerlingen, Germany. The adhesive consists of the hotmelt adhesive Vestoplast® 608 from Degussa AG, Germany.

The conductor foil projecting according to FIG. 2 at the two opposite ends of the stack and belonging in each case to like electrodes are welded to one another and to a metallic conductor vane in the uncoated regions by means of ultrasonic welding.

This stack is used for constructing a laminate sheet battery by carefully placing the stack in an aluminum housing. The cell is welded by means of an Audionvac vacuum welding unit (VMS103, from Audion Elektro GmbH, the Netherlands). 1 M LiPF₆ in EC:DEC (1:1), UBE Japan, is introduced into the housing which is still open in a small area. Thereafter, the cell is closed likewise using the vacuum welding unit, and then connected to the Series 4000 charger (Maccor, USA).

This battery can be formed and charged without problems. In contrast to comparative example 1, short-circuits do not occur in any case since the layers are well fixed to one another. In contrast to comparative examples 2 and 3, the process time could be substantially shortened since the adhesive bonding of the entire stack can be effected batchwise in parallel. Moreover, the batteries have a higher energy density since the projection of 4 mm each on both sides in the case of the pockets can be dispensed with.

### Example 2

### Stack with UV-Crosslinking Acrylate Adhesive, Adhesively Bonded Over Lines

A separator S240 P25 having the dimensions 72 mm×126 mm (Degussa AG, Germany) is placed on an electrode A (anode) having the dimensions 70 mm×131 mm (including 7 mm of uncoated copper on the narrow side), according to FIG. 2 (Enax Inc., Japan), so that the separator projects by 1 mm on all sides beyond the electrodes in the region of the copper foil coated with active material. The opposite electrode having the dimensions 65 mm×129 mm (including 9 mm of bare aluminum foil), (cathode; Enax Inc., Japan) is then placed on top, it being necessary to ensure that the separator completely covers on all sides the region of the aluminum foil coated with active material. The electrodes are arranged in such a way that the bare aluminum foils project from the stack beyond the narrow sides of the cathodes on one side of the stack, and the bare copper foils project beyond the narrow sides of the anodes on the opposite side of the stack. Further layers of electrodes are then stacked alternately, separated in each case by separators, so that a stack consisting of 16 layers of anodes and 15 layers of cathodes and 30 layers of separators finally forms, which stack is bounded by the anodes. This stack, which is slightly compressed by metal plates above and below the stack with N/cm², is provided according to FIG. 3, at 3 points (about 2 ml), with an adhesive line, said lines being applied by means of a pipette. The adhesive consists of UV-curing acrylate adhesive Plex® 9016-O from Röhm GmbH, Germany. The adhesive is cured using a UV lamp of the type UV-F 400 from Panacol-Elosol for 15 min at a wavelength of from about 315 to 380 nm.

The conductor foils projecting according to FIG. 2 at the two opposite ends of the stack and belonging in each case to like electrodes are welded to one another and to a metallic conductor vane by means of ultrasonic welding in the uncoated regions.

This stack is used for constructing a laminate sheet battery by carefully placing the stack in an aluminum housing. The cell is welded using an Audionvac vacuum welding unit (VMS103, from Audion Elektro GmbH, the Netherlands). 1 M LiPF₆ in EC:DEC (1:1), UBE Japan, is introduced into the housing which is still open in a small area. Thereafter, the cell is likewise closed using the vacuum welding unit, and then connected to the Series 4000 charger (Maccor, USA).

This battery can likewise be formed and charged without problems. In contrast to comparative example 1, here too short-circuits do not occur in any case since the layers are well fixed to one another. In contrast to comparative examples 2 and 3, the process time could also be substantially shortened since the adhesive bonding of the entire stack can be effected batchwise and in parallel. Moreover, the batteries have a higher energy density since it is possible to dispense with the projection of 4 mm on both sides in the case of the pockets.

### Example 3

### Stack with UV-Crosslinking Acrylate Adhesive, Adhesively Bonded Over the Whole Lateral Area

A separator S240 P25 (Degussa AG, Germany) having the dimensions 72 mm×126 mm is placed on an electrode A (anode) having the dimensions 70 mm×131 mm (including 7 mm Cu edge), according to FIG. 2 (Enax Inc., Japan), so that the separator projects by 1 mm on all sides beyond the electrodes in the region of the copper foil coated with active material. The opposite electrode having the dimensions 65 mm×129 mm (including 9 mm of bare aluminum foil), (cathode; Enax Inc., Japan) is then placed on top, it being necessary to ensure that the separator completely covers on all sides the region of the aluminum foil coated with active material. The electrodes are arranged in such a way that the bare aluminum foils project from the stack beyond the narrow sides of the cathodes on one side of the stack, and the bare copper foils project beyond the narrow sides of the anodes on the opposite side of the stack. Further layers of electrodes are then stacked alternately, separated in each case by separators, so that a stack consisting of 16 layers of anodes and 15 layers of cathodes and 30 layers of separators finally forms, which stack is bounded by the anodes.

This stack which is slightly compressed by metal plates above and below the stack with 10 N/cm² is provided with an adhesive layer according to FIG. 4 over the whole area in the region of the width L. The adhesive consists of UV-curing acrylate adhesive Plex® 9016-O from Röhm GmbH, Germany. The adhesive is applied by immersing the lateral area in an adhesive bath. Any resulting drops of adhesive are scraped off with a spatula. The adhesive is cured using a UV lamp of the type UV-F 400 from Panacol-Elosol for 15 min at a wavelength of from about 315 to 380 nm.

The conductor foils projecting according to FIG. 2 at the two opposite ends of the stack and belonging in each case to like electrodes are welded to one another and to a metallic conductor vane by means of ultrasonic welding in the uncoated regions.

This stack is used for constructing a laminate sheet battery by carefully placing the stack in an aluminum housing. The cell is welded using an Audionvac vacuum welding unit (VMS103, from Audion Elektro GmbH, the Netherlands). 1 M LiPF₆ in EC:DEC (1:1), UBE Japan, is introduced into the housing which is still open in a small area. Thereafter, the cell is closed likewise using the vacuum welding unit, and then connected to the Series 4000 charger (Maccor, USA).

This battery can likewise be formed and charged without problems. In contrast to comparative example 1, here too short-circuits do not occur in any case since the layers are well fixed to one another. In contrast to comparative examples 2 and 3, the process time could likewise be substantially shortened since the adhesive bonding of the whole stack can be effected batchwise and in parallel. Moreover, the batteries have a higher energy density since it is possible to dispense with the projection of 4 mm on both sides in the case of the pockets. The handling is even further improved compared with the two examples 1 and 2 with partial adhesive bonding.

1: A stack comprising separators and electrodes stacked alternately one on top of the other and fixed, wherein the stack has, on at least one side and/or edge of the stack, at least one adhesive bond comprising an organic adhesive, which bond adhesively bonds the electrodes and separators of the stack to one another.

2: The stack as claimed in claim 1, which has at least one adhesive bond on two or three sides and/or edges.

3: The stack as claimed in claim 1, which has, on at least one side, a sufficient number of adhesive bonds for the spacing of the adhesive bonds to be from 20 to 0.1 cm.

4: The stack as claimed in claim 1, wherein the length of the sum of all adhesive bonds accounts for from 0.1 to 100% of the length of the side of the stack, the length of the side of the stack being determined only by those parts of the stack in which the active sections of the electrodes are arranged one on top of the other.

5: The stack as claimed in claim 1, wherein the width of an individual adhesive bond is less than 2 cm.

6: The stack as claimed in claim 1, wherein the width of an adhesive bond accounts for from 0.1 to 100% of the length of the side of the stack.

7: The stack as claimed in claim 1, wherein at least two adhesive bonds are present on two opposite sides.

8: The stack as claimed in claim 1, wherein the organic adhesive is an epoxy adhesive, a hotmelt adhesive or an acrylate adhesive.

9: The stack as claimed in claim 1, wherein anodes and cathodes, which are separated from one another in each case by a separator, are stacked alternately one on top of the other in the stack.

10: The stack as claimed in claim 1, which has in each case an electrode as first and last layer, these electrodes being in each case cathodes or in each case anodes.

11: The stack as claimed in claim 1, wherein the separators terminate with the active regions of the electrodes directly adjacent to them and/or project beyond the active regions of the electrodes directly adjacent to them.

12: The stack as claimed in claim 1, wherein the separator is a ceramic separator or a separator which comprises ceramic components.

13: A method for the production of a stack comprising separators and electrodes stacked alternately one on top of the other and fixed, wherein separators and electrodes are stacked alternately on an electrode and an adhesive bond which has contact at least with one side of the electrodes and separators present in the stack is applied to at least one side of the stack thus obtained.

14: The method as claimed in claim 13, wherein, for applying the adhesive bond to at least one side of the stack, an organic adhesive is applied by means of injection heads for bead application, large-area heads, spray heads, metering valves or dispensers to at least one side of the stack and the electrodes and separators contained in the stack are then not moved relative to one another until the adhesive has cured.

15: The method as claimed in claim 13, wherein an organic adhesive which cures or can be cured within from 0.1 to 60 minutes is used for the production of the adhesive bond.

16: The method as claimed in claim 13, wherein at least that side of the stack to which an adhesive bond is to be applied is compressed by exerting pressure.

17: The method as claimed in claim 13, wherein, during stacking, anodes and cathodes are stacked alternately one on top of the other as electrode types, and in each case a separator is stacked between the electrodes, the separator having a greater width than at least one of the two electrode types.

18: The method as claimed in claim 17, wherein a separator which has a 0.1 to 10 mm greater width than the width of the anodes and/or cathodes used is used.

19: The method as claimed in claim 17, wherein a separator which has a greater width than the width of the cathodes used is used.

20: The method as claimed in claim 13, wherein a stack is produced therewith.

21: The method of using a stack as claimed in claim 1 in a Li battery.

22: A Li battery containing a stack as claimed in claim 1.
